(19) United States
(12) Patent Application Publication
(10) Pub. No.: US 2024/0033596 A1
(43) Pub. Date: Feb. 1, 2024

(54) THROWER HAVING RESILIENT BALL HOLDER AND FLEXIBLE LINE

(71) Applicant: Benjamin Jay Herman, Longmont, CO (US)

(72) Inventor: Benjamin Jay Herman, Longmont, CO (US)

(21) Appl. No.: 18/361,766

(22) Filed: Jul. 28, 2023

Related U.S. Application Data
(60) Provisional application No. 63/393,156, filed on Jul. 28, 2022.

(51) Int. Cl. A63B 65/12; A01K 15/02

(52) U.S. Cl. CPC A63B 65/122; A01K 15/025

(57) ABSTRACT

A ball thrower having a resilient ball holder attached to a flexible line, which may be used to play with a pet dog. After the ball is loaded into frictional engagement with the resilient receiving end of the holder, the user can grip the opposite end of the flexible line before undertaking a forward throwing motion like a pitcher. The user first moves the thrower backward in a cocking phase, and then whipping forward in an acceleration phase until the ball has enough angular momentum to overcome the frictional engagement of the resilient receiving end of the holder such that the ball is thrown forward from the holder while the user holds onto the end of the line in a release phase.

### REFERENCE TO RELATED APPLICATIONS

The present application claims the benefit of co-pending Provisional Patent Application No. 63/393,156, filed Jul. 28, 2022, entitled “Ball Thrower and Pet Tug Toy,” by Benjamin Jay Herman. The disclosure of this Provisional Patent Application is incorporated by reference herein in its entirety.

### FIELD OF THE INVENTION

The present invention relates to methods and devices for throwing a ball.

### BACKGROUND ART

The following description includes information that may be useful in understanding the present invention. It is not an admission that any of the information provided herein is prior art or relevant to the presently claimed invention, or that any publication specifically or implicitly referenced is prior art.

Pet owners commonly throw objects out some distance for the pet such as a dog to retrieve and return to the owner. One commonly thrown object is a tennis ball. Throwing devices may be used to provide some mechanical advantage in throwing an object.

Known throwing devices to throw balls for playing with pets, such as tennis ball launchers, use a long, rigid arm, often made of plastic, with a cradle on one end to hold a ball and a handle at the other end for the user. The ball is released and thrown when the device is swung in a catapult fashion. One example of this type of throwing device is disclosed in U.S. Pat. No. 8,857,419. Another example of a hinged ball thrower is disclosed in U.S. Pat. No. 7,032,583. Long, rigid arms can be inconvenient to store or transport.

Other known throwing devices use a slingshot design such as a frame attached to one end of two elastic straps with the other ends leading to a pouch that holds the projectile object. A person would hold the frame with one hand, while the other hand grasps the pouch, drawing it back and stretching the elastic bands. When the pouch is released, the elastic bands throw the projectile forward. One example of this type of throwing device is disclosed in U.S. Pat. No. 6,595,160.

Another throwing device known as a sling consists of a pouch or cradle held by two long straps, and a rock or other projectile could be placed in the pouch. The thrower would grip the ends of the straps and spin the pouch with the rock in a circular motion until reaching a sufficient speed wherein one of the straps is then released to cause the rock to be thrown from the pouch. The story of David and Goliath, in which David defeats Goliath with a well-aimed shot to the head with a rock from David's sling, is a well-known example of using a sling; although one should not use a sling to fling projectiles at the head of one's pet dog.

The present invention addresses these limitations by providing for a novel device for throwing a ball.

### SUMMARY OF THE INVENTION

The present invention provides methods and devices for throwing a ball.

In one embodiment, the throwing apparatus comprises a holder having an open end, and a base end opposite to the open end, wherein the open end of the holder forms a receiving cavity configured to receive and frictionally engage a portion of a ball having a ball circumference; a line having a first end configured to allow a user to grip, and a second end attached to the base end of the holder, wherein the line is flexibly flaccid; wherein, when a user undertakes a pitching motion while holding onto the first end of the line to throw the spherical ball from the holder, the holder moves backward and then forward until the spherical ball has enough angular momentum to overcome the frictional engagement of the open end of the holder during the forward movement so that the ball is thrown forward from the holder while the user holds onto the line.

The holder may further include an aperture in the base end in fluid communication with the receiving cavity to avoid forming a vacuum when the ball is engaged in the receiving cavity. Where the holder further includes a base cavity located between the receiving cavity and the base end, the base cavity containing a portion of the line, the base cavity further being in fluid communication with the receiving cavity, and the base end of the holder further including an aperture in fluid communication with the base cavity to avoid forming a vacuum when the ball is engaged in the receiving cavity. The holder also may include a plurality of kerfs formed at the open end of the receiving cavity.

The second end of the line may further act as a tug toy with a pet when the user grips the outer diameter of the holder. The holder may have exterior protrusions for gripping.

An embodiment of the method of throwing comprising the steps of loading a ball in a holder having an open end, and a base end to the open end, wherein the open end of the holder forms a receiving cavity configured to receive and frictionally engage a portion of the ball; gripping a first end of a flexible line having a base end attached to the base end of the holder, and a free end configured to allow a user to grip as a handle; undertaking a pitching motion while holding onto the free end of the line to throw the ball from the holder, during which the holder moves backward and then forward until the ball has enough angular momentum to overcome the frictional engagement of the open end of the holder during the forward movement so that the ball is thrown forward from the holder while the user holds onto the line. The method may further comprise the steps of gripping the holder and presenting the free end of the line to a pet as a tug toy, wherein the free end of the line has a section configured for the pet to bite upon.

Other features and advantages of the present invention will become more apparent from the following detailed description of the invention, when taken in conjunction with the accompanying exemplary drawings.

### BRIEF DESCRIPTION OF THE DRAWINGS

FIG. 1 depicts a perspective view of an embodiment of the present invention.

FIG. 2 is an embodiment of the present invention with a ball loaded into the receiving end of the holder.

FIG. 3 is a top view of an embodiment of the present invention without a ball loaded into the receiving end of the holder or the line attached to the base end of the holder.

FIG. 4 is a perspective bottom view of an embodiment of the present invention without the line attached to the base end of the holder.

FIG. 5 is a perspective bottom view of an embodiment of the present invention without the line attached to the base end of the holder.

FIG. 6 is cross-sectional view of the holder taken along lines 6-6 in FIG. 5 in accordance with an embodiment of the present invention.

FIG. 7 is a side view of an embodiment of the present invention showing different phases of a throwing motion while in use.

FIG. 8 illustrates an embodiment of the present invention being used as a tug toy.

FIG. 9 is a top perspective view of an alternative embodiment of the holder having slits in the receiving end in accordance with the present invention.

FIG. 10 is a top perspective view of another alternative embodiment of the holder having slits in the receiving end and conically-arranged nubs in accordance with the present invention.

FIG. 11 is a top perspective view of another alternative embodiment of the holder having notches in the receiving end and an eyelet at the base end in accordance with the present invention.

FIG. 12 is another alternative embodiment of the present invention configured to simulate a squirrel.

### DETAILED DESCRIPTION

In various embodiments, the ball thrower includes a resilient ball holder attached to a flexible line. The user places a ball such as a tennis ball into the holder, grips one end of the line, and engages in a forward rotational throwing motion. During the forward throwing motion, the rotational forces acting on the ball overcomes the holder's resilient grip on the ball, and the ball is thrown forward. The throwing motion also may be characterized as a pitching motion or whipping motion.

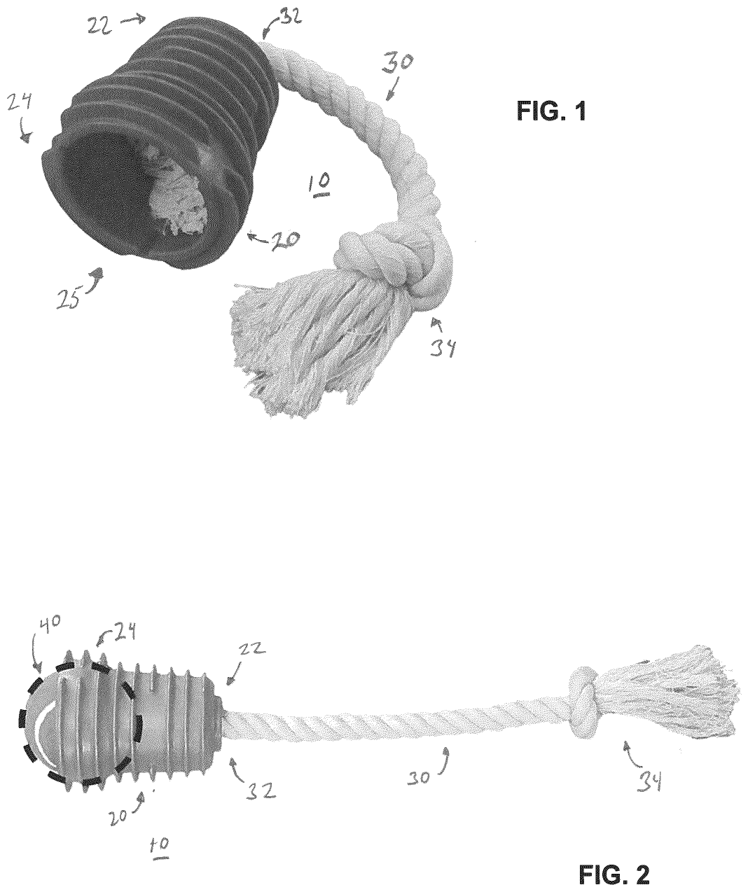

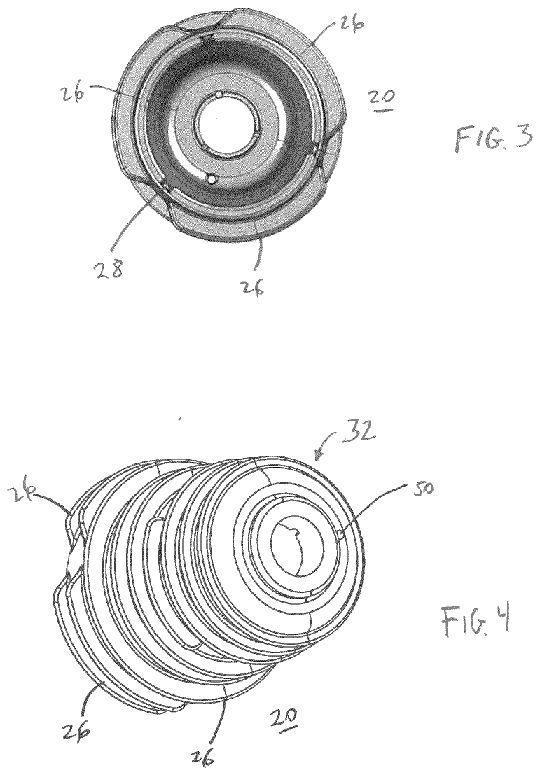

As illustrated in FIGS. 1 and 2, this embodiment of the ball thrower 10 includes a ball holder 20 attached to a flexible flaccid line 30 having two ends, a base end 32 and a free end 34. The ball holder preferably has a cup shape with a base end 22 and a receiving end 24. The base end 32 of the line 30 is attached to the base end 22 of the holder 20. The receiving end 24 of the holder 20 has a receiving cavity 25 with a resilient opening configured to receive a ball 40. The ball 40 is preferably a pressurized tennis ball or other spherical object. The circumference of the opening of the receiving end 24 is preferably slightly smaller than the circumference of the ball 40. The resilient receiving end 24 preferably slightly wraps around the ball 40 in a friction fit. The receiving end 24 of the holder is preferably made from an elastomeric material such as rubber or a plastic elastomer. For ease of manufacture, the entire holder 20 preferably is made from the same material to form a resiliently rigid structure. The holder's structure should be sufficiently resilient to slightly deform at the circumference of the opening of the receiving end to accept the loading of a ball with a slightly larger circumference; while sufficiently rigid to maintain a cup shape during the throwing operation.

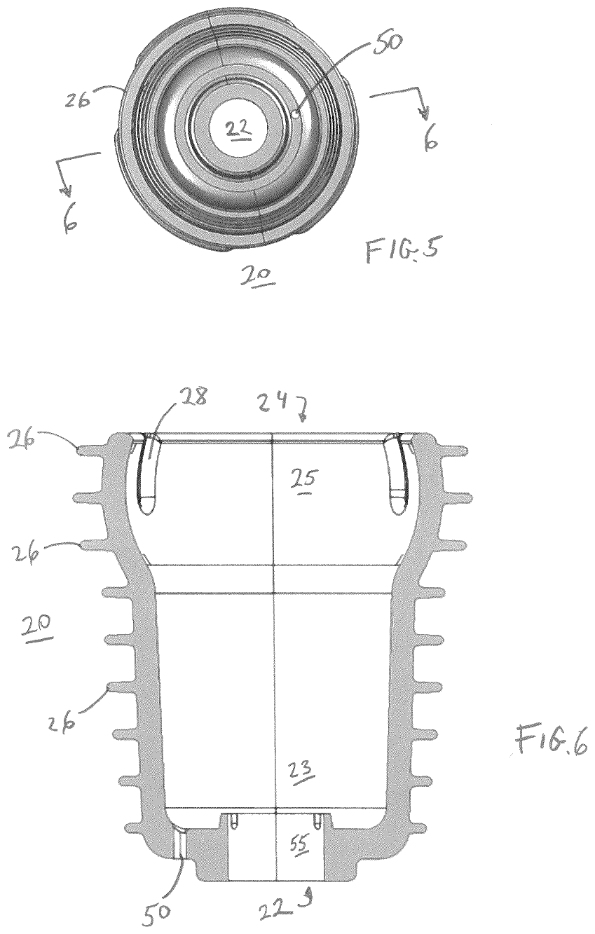

FIGS. 3 through 6 show additional views of the holder 20 of this embodiment without the line. The resilient receiving end 24 of the holder 20 grips the ball 40 with a friction-fit when the circumference, or greatest cross-section, of the ball moves past the opening of the receiving end. Kerfs (notches or slits) preferably are formed along the circumference of the receiving end to increase the flexibility of the receiving end at the circumference to improve the acceptance and release of a ball at the receiving end's opening. The increased flexibility and stretchability provided by the kerf can help the receiving end of the holder accept different-sized balls. The kerfs may be part of the formed in an injection molding process for the ball holder. In the alternative, the kerfs may be formed afterwards.

Notches 28 may be formed along the inner edge of the circumference of the receiving end 24 where the receiving end's opening meets the ball 40. The notches 28 provide increased flexibility around the receiving end to accept the loading of the ball 40 into the receiving cavity 25.

To avoid creating a suction effect when the ball 40 is loaded into the receiving cavity 25 of the holder 20 which may prevent proper release of the ball during the throwing operation, a small air opening or aperture 50 can be formed in the body of the holder 20. For example, a small air opening 50 may be formed in the base end 22. Air openings or aperture also may be formed along the sides of the holder 20 in alternative embodiments. The air opening or aperture acts as a venting hole or vacuum relief aperture.

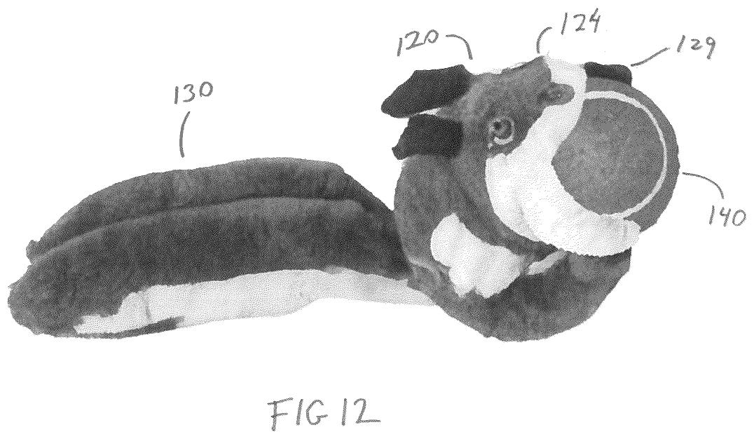

The base end 32 of the line 30 is attached to the holder 20, and the free end 34 of the line 30 at the opposite end may be enlarged for the hand of a user to grasp. When holding onto the line 30 before any throwing motion, gravity will cause the holder 20 to drop down. The line 30 should not hold up the holder 20. The line 30 is flexible and flaccid, and preferably is inelastic or have a low longitudinal elasticity or low stretching in the longitudinal direction. The line 30 can be a braided cotton rope with one end 32 passing through an opening 55 in the base end 22 of the holder 20 and then tied into a stopper knot that prevents that end 32 from passing back out of the opening in the base end 22. The stopper knot can reside within a base cavity 23 formed behind the receiving cavity 25, where the base cavity 23 and receiving cavity 25 are in air or fluid communication with one another. The opposite free end 34 of the rope line 30 also may be tied into another stopper knot to act as a handle to improve grip for the user. The line 30 can employ different configurations of loops, number of knots, and lengths for the rope. In the alternative, the line can be a leather strap or thong, a sleeved chain, or other long flexible structure. Also, instead of threading the line through an opening in the base end of the holder, the line could be affixed to the base end using an adhesive, riveting, or overmolding. The line also may be tied or looped the line through an eyelet 110 formed at the back of the base in the embodiment illustrated in FIG. 11.

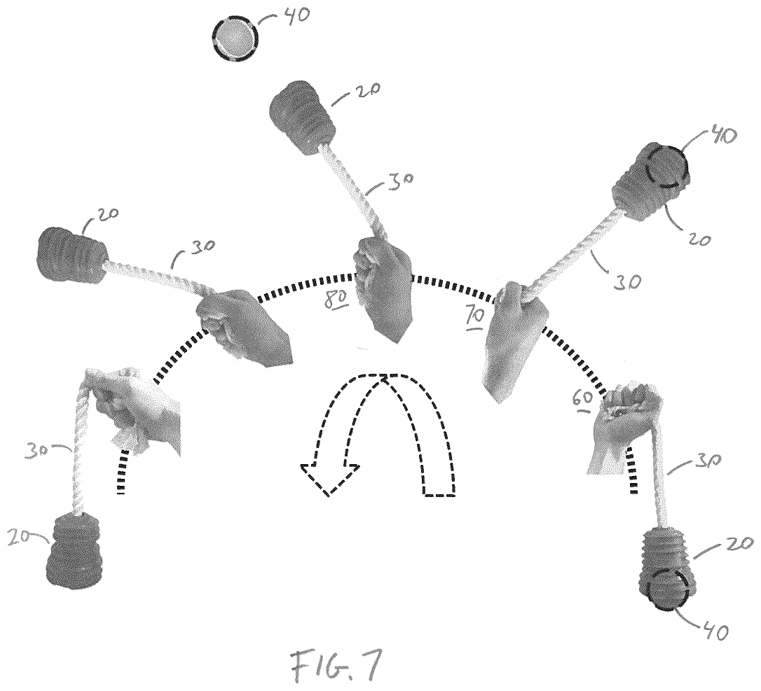

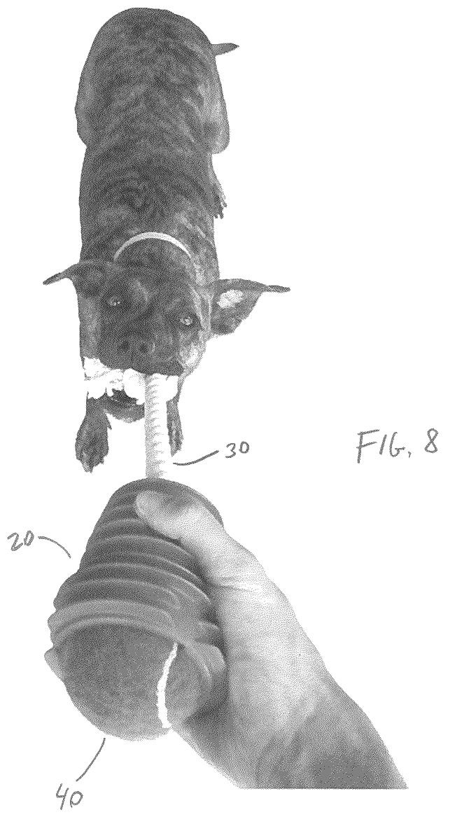

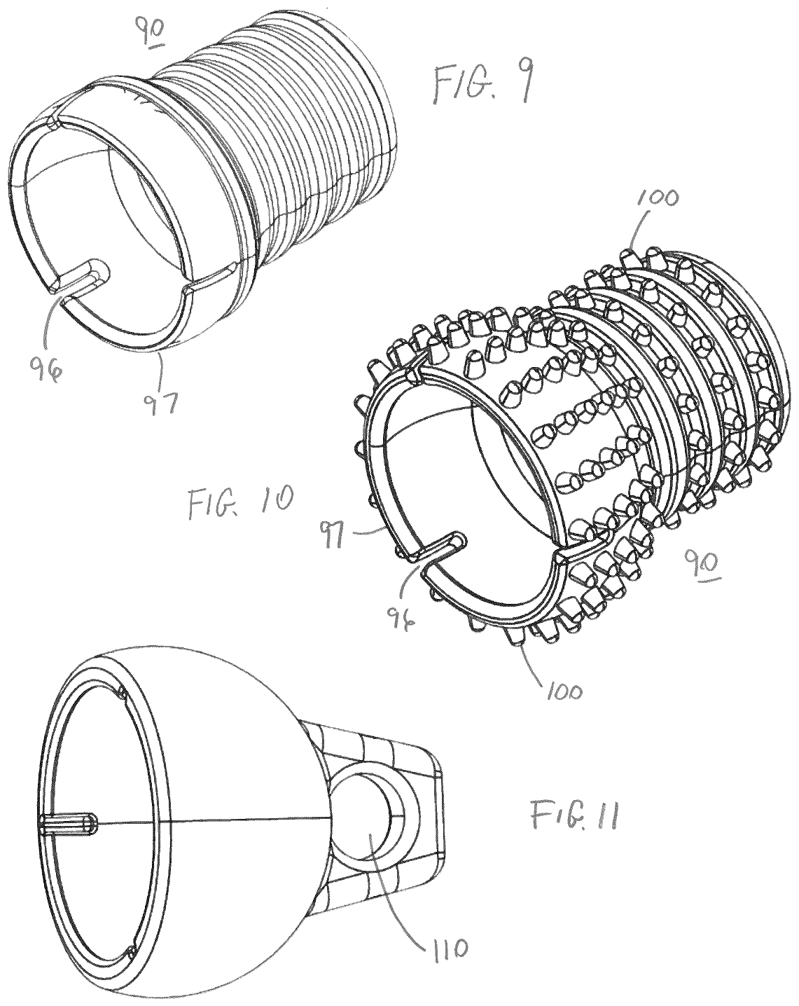

In use, as illustrated in FIG. 7, after the ball 40 is loaded into the cavity 25 of the receiving end 24 of the holder 20, the use can grip the opposite end 34 of the line 30 and swing the thrower 10 in a forward pitching motion to launch the ball 40. The user first moves the thrower 10 backward in a cocking phase 60, and then whipping forward in an acceleration phase 70 until the ball has enough angular momentum to overcome the frictional engagement of the open receiving end 24 of the holder 20 around the apex of the forward throwing motion, such that the ball 40 deforms the resilient open receiving end 24 of the holder 20 and the ball 40 is thrown forward from the holder 20 while the user holds onto the end 34 of the line 30 in a release phase 80. A line 30 having flexibly flaccid characteristics promotes a whipping action in which the forces acting on the ball cause it to overcome the friction from the resilient receiving end of the holder so as to be released near the apex of the throwing motion.

When not in use, the line 30 can be wrapped on or around the holder 20 so as to be stored or transported in a compact configuration. This compact configuration could fit into a typical handbag or drawer.

In addition to functioning as a thrower, the present invention also can be used as a tug toy with a pet. As illustrated in FIG. 8, the user can grip onto the body of the holder 20 and the pet can bite onto the opposite, knotted, free end 34 of the line 30. The user can grip onto the body of the holder 20 with the receiving end 24 empty, or with a ball 40 in the receiving cavity of the holder 20.

Circumferential ridges 26 may be formed along the sides of the holder 20 to provide varying degrees of additional structural stability or stiffness. For example, where the ridges 26 have breaks or gaps 28, the gap section would be less stiff than the sections where the ridges protrude.

The ridges 26 can enhance gripping of the holder 20 by a user. In addition, the gaps 28 can allow the fingertips of a user to directly contact the sides of the holder 20. This can improve the grip along the lower base section of an empty holder 20. And this can improve grip along the receiving end 24 when a ball is placed into the receiving cavity 25 of the holder 20.

Protrusions other than ridges may be formed along the sides of the holder. For example, conical protuberances or nubs 100 may be formed along the sides of the holder as illustrated in FIG. 10.

In addition to functioning as a tug toy, the thrower 10 itself also may be thrown, with or without a ball 40 in the holder 20, and used as a fetch toy when playing with a pet.

Although the base end 22 of the holder 20 is shown as having a smaller circumference than the receiving end 24, the base end could have a larger circumference than the receiving end in an alternative embodiment.

An alternative embodiment of the holder is illustrated in FIG. 9. The holder 90 here is similar to the previously described holder 20, except that the resilient receiving end 94 of the holder 90 has slits 96 in the walls forming the receiving cavity 95 to form finger-like tines 97 that can allow larger-sized balls to fit. The tines 97 can resiliently accept balls with a larger circumference and still grips the larger ball with a friction-fit when loaded into the receiving cavity 25.

In an alternative embodiment, instead of using a rope for the line 30, the holder 20 and the line 30 could be fabricated from the same elastic material in a one-shot mold process. In this alternative embodiment, the line 30 should have sufficient thickness so as to avoid excessive elongation from the elastic material during the throwing process. Excessive elongation may lead to a loss of control or breakage of the line.

In another alternative embodiment illustrated in FIG. 10, the holder 120 and the line 130 is covered with a fabric to simulate a squirrel. The flexible flaccid line 130 forms the core for the squirrel's tail while the holder 120 forms the body of the squirrel. The holder's receiving end 124 would simulate the mouth and limbs of the squirrel which would hold the ball 140. The receiving end 124 can be irregularly-shaped and form finger-like tines 129 to hold the ball 140. In yet another alternative embodiment, instead of a two-piece construction, the holder and line may be fabricated from the same elastic material in a one-shot mold process, and then covered with a fabric to simulate a squirrel. Other creatures such as foxes, raccoons, and skunks, or fanciful creatures such as dragons, can be simulated as well.

Although embodiments of the invention are described, it is understood that not every possible embodiment of the invention is shown and described herein. Unless specifically noted, the words and phrases in the specification and claims are intended to be given the ordinary and accustomed meanings to those of ordinary skill in the applicable art.

What is claimed:

1. An apparatus comprising:
a holder having an open end, and a base end opposite to the open end, wherein the open end of the holder forms a receiving cavity configured to receive and frictionally engage a portion of a ball having a ball circumference;
a line having a first end configured to allow a user to grip, and a second end attached to the base end of the holder, wherein the line is flexibly flaccid;
wherein, when a user undertakes a pitching motion while holding onto the first end of the line to throw the spherical ball from the holder, the holder moves backward and then forward until the spherical ball has enough angular momentum to overcome the frictional engagement of the open end of the holder during the forward movement so that the ball is thrown forward from the holder while the user holds onto the line.

2. The apparatus of claim 1, wherein the holder further includes an aperture in the base end in fluid communication with the receiving cavity to avoid forming a vacuum when the ball is engaged in the receiving cavity.

3. The apparatus of claim 1, wherein the holder further includes a base cavity located between the receiving cavity and the base end, the base cavity containing a portion of the line, the base cavity further being in fluid communication with the receiving cavity, and the base end of the holder further including an aperture in fluid communication with the base cavity to avoid forming a vacuum when the ball is engaged in the receiving cavity.

4. The apparatus of claim 1, wherein the holder includes a plurality of kerfs formed at the open end of the receiving cavity.

5. The apparatus of claim 1, wherein the second end of the line being further configured to act as a tug toy with a pet when the user grips the outer diameter of the holder.

6. The apparatus of claim 1, wherein the holder has exterior protrusions for gripping.

7. A method comprising the steps of:
loading a ball in a holder having an open end, and a base end to the open end, wherein the open end of the holder forms a receiving cavity configured to receive and frictionally engage a portion of the ball;
gripping a first end of a flexible line having a base end attached to the base end of the holder, and a free end configured to allow a user to grip as a handle;
undertaking a pitching motion while holding onto the free end of the line to throw the ball from the holder, during which the holder moves backward and then forward until the ball has enough angular momentum to overcome the frictional engagement of the open end of the holder during the forward movement so that the ball is thrown forward from the holder while the user holds onto the line.

8. The method of claim 7, further comprising the steps of gripping the holder and presenting the free end of the line to a pet as a tug toy, wherein the free end of the line has a section configured for the pet to bite upon.

9. The method of claim 7, wherein the holder further includes an aperture in the base end in fluid communication with the receiving cavity to avoid forming a vacuum when the ball is engaged in the receiving cavity.

10. The method of claim 7, wherein the holder further includes a base cavity located between the receiving cavity and the base end, the base cavity containing a portion of the line, the base cavity further being in fluid communication with the receiving cavity, and the base end of the holder further includes an aperture in fluid communication with the base cavity to avoid forming a vacuum when the ball is engaged in the receiving cavity.

11. The method of claim 7, wherein the open end of the receiving cavity has a circumference smaller than the ball circumference of the ball, and a plurality of kerfs formed along the circumference of the open end of the receiving cavity, wherein the portion of ball with the ball circumference is within the receiving cavity behind the opening.

12. The method of claim 7, wherein the holder includes a plurality of kerfs formed at the open end.

13. An apparatus for throwing a ball, comprising:
means for ball holding;
means for pressure relief formed in the means for ball holding;
means for whipping attached to the means for ball holding;
wherein, when a user holds onto the means for whipping and moves the means for whipping backward and then forward to create enough angular momentum for the ball to be released from the means for ball holding.

14. The apparatus of claim 13, means for increasing flexibility of the means for ball holding where the means for ball holding holds the ball.

15. The apparatus of claim 14, wherein the means for increasing flexibility includes kerfs.

16. The apparatus of claim 15, wherein the means for holding includes a holder having an open end, and a base end opposite to the open end, wherein the open end of the holder forms a receiving cavity configured to receive and frictionally engage a portion of a ball having a ball circumference.

17. The apparatus of claim 16, wherein the holder further includes an aperture in fluid communication with the receiving cavity to avoid forming a vacuum when the ball is engaged in the receiving cavity.

18. The apparatus of claim 16, wherein the means for whipping includes a line having a first end configured to allow a user to grip, and a second end attached to the base end of the holder, wherein the line is flexibly flaccid.
